(19) United States
(12) Patent Application Publication
(10) Pub. No.: US 2009/0075592 A1
(43) Pub. Date: Mar. 19, 2009

(54) METHOD AND DEVICE FOR CONTROLLING AND PROVIDING INDICATIONS OF COMMUNICATION EVENTS

(76) Inventors: Sebastian Nystrom, Espoo (FI); Lauri Pesonen, Espoo (FI); Mikko Saarisalo, Kantvik (FI); Jarkko Sevanto, Vantaa (FI)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/097,602

(22) PCT Filed: Dec. 16, 2005
(86) PCT No.: PCT/IB05/03811

§ 371 Date: Sep. 5, 2008

(51) Int. Cl. H04B 5/00; H04B 1/38

(52) U.S. Cl. 455/41.1; 455/558

(57) ABSTRACT

The present invention relates to the field of contact-less transactions, in particular to the field of near field communication and more particularly to smart card transactions over radio frequency identification interface. The present invention relates also to a method and system for providing a user of a mobile terminal with additional information and control over various transaction processes and at the same time additional visibility to various transaction service providers by providing indications of near field communication events on a near field communication device, with the steps of detecting a near field communication event, obtaining at least one indication of near field communication events in accordance with said detected near field communication event, and providing said at least one obtained indication.

The present invention relates to the field of contact-less transactions, in particular to the field of near field communication and more particularly to smart card transactions over radio frequency identification interface. The present invention relates also to a method and system for providing a user of a mobile terminal with additional information and control over various transaction processes and at the same time additional visibility to various transaction service providers.

The present invention discloses a new way to enable third parties such as e.g. credit card companies to implement branding in a way wherein all the branding elements can be installed to the device afterwards (i.e. no product variants needed with pre-installed branding elements for contact-less transactions) and played/shown depending on the triggers specified by the third party who owns the brand/the application.

When mobile phones integrate both near field communication (NFC)/radio frequency identification (RFID) and smart card technology, they can be used as contact-less transaction device e.g. for local contact-less credit card payments or as a contact-less transportation ticket. Also, NFC enables users to have easy access to various mobile services by simply reading tags that contain service shortcuts such as URLs or SMS service messages. Furthermore, NFC enables users to easily share content locally simply by bringing two NFC devices close to each other. In a mobile phone based contact-less card infrastructure the actual contact-less applications are typically installed to the phone after the device has been sold (wherein the installation can happen e.g. over-the-air) instead of pre-installing them to the phone in the factory. This is due to the fact that mobile phone manufacturer may not now what applications such as credit cards the end-user will want to use.

When mobile phone is used as a device for contact-less transactions such as credit card payments, the companies owning the contact-less applications have an interest to have their brand visible on the device. In traditional contact-less transactions the brand of e.g. a Credit Card Company can be made visible by printing it on the plastic credit card or key fob. In mobile phones that integrate NFC and smart card technology there is typically very limited capabilities of providing printed 3rd party branding, as that would require possibly design variants of the phone. An alternative way of providing branding capabilities to third parties such as credit card companies is to utilize the user interface features (display, sound, vibration etc.) of the mobile phone.

When considering multi-application secure smart cards integrated in mobile terminals, there is lots of sensitive information relating to a user of the mobile terminal accessible to external reader devices. A typical multi-application secure smart card might include, for example, one or more general credit cards, customer loyalty cards, specific credit providing customer cards (e.g. cards for buying fuel on certain gas stations), travel cards (various tickets for e.g. subway, trains and/or buses), other kind of tickets (e.g. for swimming halls or movie theaters), customer cards (e.g. library cards, security cards etc.) and identification cards (social security cards).

Today, a smart card will respond to any kind of requests from a smart card reader by transferring an application ID. In smart card solutions multiple card applications can be stored on the same card. Up to now there is no way for the user to know which applications were requested from a reader device. It is therefore possible that a NFC reader device may request common applications form a card, and may extract information about which applications are present on the card, wherein this information may be used from a reader device to automatically collect profile data of a large number of users. This information can be of use for the benefit of the reader for marketing and sales efforts, or even tracking of individual or common user behavior. It should be possible to enable a user to prevent or restrict this kind of use of his personal data. It may also possible that the external point of sale (POS) terminal or like is trying to maliciously misuse one or more smart card applications by requesting user data of the mobile terminal to provide e.g. a loyalty card but instead looks for credit card applications to create charging from the user's credit card account.

Therefore, it is desirable for a user of the mobile terminal to control the accessibility of the various information fields stored on the secure smart card module to prevent unwanted screening/tracking of the user's sensitive information without user's permission.

For the provider of a transaction service it seems to be desirable to have means to indicate that currently ongoing transaction is provided by said entity/provider. So, in other words, e.g. credit card provider would like to have some indication of his company provided on a mobile terminal for related transactions.

According to a first aspect of the present invention a method for displaying near field communication events on a near field communication device is provided. The method comprises detecting a near field communication event, obtaining at least one indication of near field communication events in accordance with said detected near field communication event, and providing said at least one obtained indication. Basically the present invention provides a near field communication surveillance functionality. The method is especially designed to be performed on a mobile near field communication device.

With the method of the present invention a user may know whenever his near field communication device sets up a communication connection or whenever a communication request is received or detected. The method can also be used to detect and log communication events that are started from an application within said near field communication device that starts a communication attempt to an external/another NFC device. That is, with this functionality a user may determine any communication and or communication attempts said near field communication device is involved in. This functionality may further be used to determine if there are any malign programs on the terminal that may unauthorisedly send data or even perform transactions. This embodiment provides user of a mobile terminal with additional information and control over various transaction processes and at the same time additional visibility to various transaction service providers.

According to another aspect/embodiment of the invention a method for controlling the access of near field communication events to near field communication applications on a near field communication device is provided. This embodiment of the method, comprises the steps of: detecting a near field communication event, identifying at least one of the entity causing said near field communication event, and one or more application requests received from said near field communication entity, allocating at least one group of applications on said near field communication device to said near field communication entity based on the identifying information, and granting said entity causing said near field communication event access to said allocated applications.

This method refers to a kind of application access control, it is for example envisaged that a device requesting a certain near field communication (NFC) application may also be provided with access to another NFC application, wile other applications can be automatically blocked. It is for example envisaged to grant a NFC entrance control of the golf club also access to a payment application in the (probably mobile) near field communication device, wile in case of a NFC bank access personal data or e.g. the golf club application is blocked. This implementation allows a user to control basic access groups to enable certain access entities to access a group of NFC applications. The present invention also enables the use to exclude certain NFC devices from accessing (at least simultaneously) other private NFC applications such as entrance control systems, connection databases or financial applications at the same time. Basically the method may be construed as a kind of access control to enable a user to exclude that a certain device requesting a certain NFC application may also access certain other NFC applications. It may be envisaged to use a NFC data exchange protocol via a NFC docking station with the home computer of user to access all NFC applications, while some NFC entities/devices may access a certain group of NEC applications and while some other NFC entities/devices be excluded from accessing any applications (i.e. a “zero group”).

In another example embodiment of the present invention the method further comprises identifying the near field communication entity causing said near field communication event, determining a group of applications on said near field communication device allocated to said identified near field communication entity, and granting said entity causing said near field communication event an access to said allocated applications.

That is, this embodiment of the present invention provides a kind of an access restriction or access control on the basis of an identification of a requesting device. That is, a certain requesting device may access a pre-defined group of applications. However, it is also envisaged to “group” the requesting (individual) devices so that a device being allocated to a certain group of devices may have access to a single or a number of defined applications of the terminal/mobile device. The grouping may be performed on the application side and/or on the device side that is the grouping may be performed by a respective dedicated control application or e.g. by a dedicated piece of hardware hardwired in a near field communication device.

In another example embodiment of the present invention the method also comprises receiving a user input to define groups of applications and allocate these groups to entities causing said near field communication events. This definition of groups and allocations form a basis for performing the above method. It is contemplated to use a “teach in” phase in which a user may select (detected, identified and depicted requesting events or entities causing a NFC event) and a number of NFC applications on said terminal device to allocate each of said entities/events one, none or a number of NFC applications that may be granted for access. It should be noted that this procedure might be assisted by kind of menu structure or assistant program to guide the user through the allocation procedure to simplify this procedure.

In an example embodiment of said method said communication event is selected from the group consisting of transaction requests, transactions, data transfer requests, data transfers. When a user has a multi-application smart card for example in his phone, a user interface can be used to show ongoing transactions and transaction requests to the user.

In yet another example embodiment the method further comprises registering detected near field communication events in a registry of detected near field communication events. That is, in this embodiment the management application of the smart card or a smart card module has a registry of transaction requests and transactions (or communication events), which can be displayed to the user e.g. after each read attempt. This will provide the user a means to expose any attempts to profile the user. It could be noted that the method might also comprise a step of generating and storing registry of detected near field communication events. When a user has a multi-application smart card for example in his phone, a user interface can be used to show ongoing and past transactions and transaction requests to the user. It is also envisaged to use the registry of transaction requests and transactions as a kind of log file, or (temporary) buffer store, storing e.g. the last 20 or 4000 communication events, transactions or transaction requests.

In yet another example embodiment the method further comprises grouping said applications of the near field communication device according to a received user input. The user input may be received via a dedicated user interface. It is also envisaged to implement e.g. a respective menu structure to simplify the man machine interface to enable a user to access the rules and to define and amend the rules or groups of applications in an intuitive manner. It is however also envisaged to provide a near field communication device with a number of preinstalled applications with pre-grouped applications. It may be noted that the applications may be grouped in one or more different groups.

In another example embodiment said method further comprises grouping said detected or stored communication events. In a basic embodiment said communication events may be grouped according to a time scheme. In another embodiment said communication events may be grouped according to a location scheme (when e.g. the near field communication device is provided with a positioning system module). It is also envisaged to implement the device in a way that the single communication attempts are correlated with respect to mutual occurrence (to determine parasitic communication/transfer attempts/events).

This step or grouping may be performed directly after detecting said communication events by storing the detected communication events in a grouped manner in the registry of detected near field communication events. It is also contemplated to perform this step when obtaining said output/providing data in accordance with said detected near field communication event(s), which would be used for a grouped registry. In the first implementation data are grouped during the detection process and in the second implementation the data are grouped during the output/providing process. Especially in case of a grouping it is envisaged to link/associate the data of detected communication events in the registry of detected near field communication events, with other supplementary data, such as background information related to said detected communication events. This may be implemented by links to externally stored data or for example to a number of pre-stored data (such as e.g. multimedia data to enrich the output/providing of the detected communication events). It is also envisaged to group the indications for output/provision via display.

This application may be used for example, at a retail store so that the user would see a list of application requests by a reader from the smart card on the terminal's display screen, identifying which applications where identified, and how many and which unknown requests where processed, or output may be triggered when a user defined or preset trigger level or requests is exceeded. The user may receive e.g., the following message “Credit card (provider) transaction initiated, 3 other requests processed”. This would lead the user to know that 3 other applications where requested, and that the reader will have now the information about the card's response to those requests.

The communication events may be grouped according to the sensitivity of the data used in a requested application and that may be accessed in a communication event such as a transaction or transaction request directed to this application. That is, a grouping pattern of the communication events is related by a one to one mapping to the grouping of the respective applications on said near field communication device. That is, sensitive application information stored in the secure smart card module is classified into various groups that differentiate the stored application information so that applications having similar characteristics are grouped to one category. Exemplary categories can be for embodied for example as
financial transactions/credit cards
customer loyalty cards,
specific credit providing customer cards (e.g. cards for buying fuel on certain gas stations),
travel cards (various tickets for e.g. subway, trains and/or buses),
other kind of tickets (e.g. for swimming halls or movie theaters),
customer cards (e.g. library cards, security cards etc.), and
identification cards (social security cards),
cards with preferred settings of vehicle,
communication access cards for telephones Internet, and the like.

In the following the grouping of the applications on the near field communication device and the grouping of access to these applications by e.g. transactions and transaction requests is summarized under a single term “grouping”.

When the applications are categorized to e.g. the above categories, there can be various rules regarding the categories, which permit/prevent certain information categories to accessible/denied to an external reader device upon requesting information from an application residing in a certain category. As an example, when e.g. transaction/credit card application is requested, also customer loyalty card category is available. However, e.g. applications in the travel card category will not be available to the external reader. On the other hand, when an application residing in the travel card category is requested, also the transaction/credit card category is available but access to the customer loyalty card category is denied.

As one feature of the invention, the user is provided a dedicated user interface to adjust and modify the settings of the categories and their linking with each other. The user interface could be a simple listing of the main categories with taggable boxes, which allows the user to make the associations between the categories to define the rules to allow/deny access to applications of a certain category when an application of another category is requested. Finally, in addition to the above, the terminal may store information that can be used in connection with various transactions to indicate the user/the provider a successful transaction.

Embodiments of the present invention does not necessarily provide direct tools to prevent the profiling, but exposes it, which is an effective way to manage privacy and ID. It is also envisaged to use a log registry with an extension to enable a blocking of transactions e.g. on the basis of e.g. unidentified or identified unwanted registry entries. In this embodiment detected or identified requesting entities may be grouped in a kind of black list to enable an accessed to (certain or all) applications only to known identified devices.

This may be achieved by a logic, which makes the transaction services more controllable for a mobile terminal user by exposing various transaction-requests to the user and grouping applications in the secure smart card into different types of sets that are controllable by the user through a dedicated user interface. Further, as an additional feature for the user interface, the present invention provides indication of the transaction service provider during transaction process itself.

In an alternative implementation the registry of detected near field communication events or log file could be collected the contact-less front-end, and the registry of detected near field communication events (or log) resides in the phone.

In yet another example embodiment of the method, said grouping is performed according to location information wherein the method further comprises determining the position of the near field communication device. In a basic embodiment the grouping is performed to determine a spatial distribution of requesting NFC readers. In a next step this collected spatial data that is connected to the detected NFC events is used as a basis for generating a personal map of requesting unknown readers and areas with known readers and known transactions. This map can be sued to deactivate any near field communication (or special applications thereof in these areas). This grouping according to the identified/unidentified distribution key is a basic for discovering transaction requests/transactions, which otherwise could not be noticed by the user. This embodiment enables user to detect and determine areas with a large number of unidentified transaction requests. This feature may enable user to deactivate a near field communication in areas with a large number of unidentified transaction requests. In general it is not possible to block certain requests, but if it is possible to define areas where there is most probably to be subjected to unwanted screening or like the user might simply deactivate the whole NFC communication in these areas. This embodiment may also comprise detecting an actual position of a device (e.g. via a cellular communication network, inertial guidance, or e.g. a positioning system such as the GPS). The detected position data may be correlated to detected unwanted transaction requests to determine/define “no transaction” or “no NFC” areas, in which it is not possible to perform NFC transactions. It is also envisaged to combine the device with a positioning module to determine locations with a large number of transaction requests and/or a large number of communication events. Such an implementation may enable user to turn the tables and do a kind of area profiling or shop profiling themselves.

In another example embodiment the method of the invention is further comprises receiving a user input for outputting/providing said obtained at least one indication and outputting/providing said data accordingly. This embodiment is directed to the implementation in which a user can retrieve the data stored in a transaction request/transaction registry can be retrieved by a user to do an “ex post” consideration of all kinds of communication events, transaction request, transactions and the like. This enables a user to avoid all places in which a large number of unknown transaction requests occur. It this embodiment the device logs all occurring events e.g. in a log file register and the user may access this register anytime he wants.

In yet another example embodiment of the invention said step of obtaining said indications in accordance with said detected near field communication event further comprises obtaining indications selected from the group consisting of playable sound files, video clips, vibration signalization files, splash screens, or images.

This embodiment relates to an implementation in which as device detects (identified or unidentified) communication events, transaction requests and/or transactions, and obtains respective (related and pre-stored) indications e.g. from a storage for output/provision. These output/provided data/indications may be used to indicate the user that a transaction or a transaction request performed. The playable sound files, video clips, vibration signalization files, splash screens, or images may e.g. comprise e.g. a brand/product name in case there is a brand/product related transaction or transaction request. It is contemplated to enable a user to configure this function. It is contemplated to use a kind of selectivity and deactivatibility to enable user to prevent the playback of a sound/video/vibration file each time he enters a less appreciated product brand or service. This embodiment may enable a user to enter the subway without that a actual display content such as an SMS or MMS screen, a gaming application or a mobile TV, e.g., DVB-H transmission has to be interrupted or changed. In accordance with the invention a user may use this implementation to get a certain signal if his phone connects to his car to output a salutation sequence via the phones loudspeakers indicating that the car has unlocked/opened the doors. Similarly, the car may use a detected NFC phone to change all settings of the car according to a detected user phone ID (however life is getting complicated when a person just takes his spouse's phone for a short trip with the car). This first embodiment may be used in firmware-integrated indication files to indicate near field communication events such as transactions and transaction requests by a number of pre-stored indications.

In yet another example embodiment of the present invention the method further comprises downloading said indications, and linking said indications with or to said near field communication events.

By downloading and installing said indications e.g. a package with branding elements may be installed to the device for example over-the-air, over local wireless communication channels e.g. Bluetooth (BT), WiFi, near field communication (NFC), Infrared (IrDa) or the like, or by using physical connection such as universal serial bus (USB) or serial cable. The contents of the branding elements/indications can be any data that the phone is able to play, reproduce or show to the user

In this solution the phone enables third parties to install indications as e.g. branding elements (e.g. playable sound file/video clip/splash screen/image) to the phone in a single package (e.g. based on extended Markup Language XML). The package may also contain definitions of the trigger conditions that will cause the indications (e.g. branding elements) to be played, reproduced or shown. It is also contemplated to combine the download with the installation of certain transfer or transaction programs. It is for example envisaged to implement a payment algorithm that is coupled with the reproduction of a sound scheme of certain funds transfer institute. These branding elements may also contain links to network based data related to the brand, e.g., a web page.

It is also contemplated the indication files e.g. the branding data and files may be shrink-wrapped into one indication installation package (Brand Package). Such a package could contain at least the following elements: Name of the package, indication or brand, a trigger definition (defined in the form of, e.g., an NDEF [NFC Data Exchange Format] type), execution, playing or reproduction instructions, and the media files as the indication itself. This data could be defined as XML structure or a proprietary binary data format.

In another example embodiment said linking is performed by defining trigger conditions for outputting/providing said downloaded indications. The triggers can be for example a specific NDEF type, a specific Application identification (detected from a contact-less card reader), or something else that can be used to recognize the type of the contact-less application/service in use.

In yet another example embodiment of the present invention said method further comprises checking if said detected or identified near field communication event fulfills said defined trigger condition; and outputting/providing said obtained indications, if said detected or identified near field communication event fulfills said trigger condition.

The mobile electronic device e.g. a phone will store the indications or branding elements and prepare to play or reproduce the indications branding elements according to the trigger conditions defined in the package. When the user e.g. reads a tag or brings the phone close to an external reader, the phone checks if the trigger condition (e.g. the NDEF type read from the tag/AID [application ID] asked by the external reader) is fulfilled, and reproduces the indications e.g. branding elements defined for or linked to that trigger condition. It is envisaged that the mobile electronic device stores multiple branding elements at the same time, to enable that e.g. a first logo to be shown after a credit card payment, and another logo to be shown when using mobile device e.g. as a ticket in a public transport system. Although above examples are about contact-less payment & ticketing, the invention is not limited to those use cases only. For example, in service discovery use cases the indications or branding elements e.g. of the service/content provider may be shown based on the NDEF type. For example in the use of a near field communication connection in a hands-free device in a vehicle or car environment.

The checking operation may also comprise additional information such as an identification of a calling or requesting party, an NDEF type, a specific Application identification (detected from a contact-less card reader), or something else that can be used to recognize the type of the contact-less applications or services in use.

According to yet another aspect of the invention, a software tool is provided comprising program code means for carrying out the method of the preceding description when said program product is run on a computer or a network device.

According to another aspect of the present invention, a computer program product downloadable from a server for carrying out the method of the preceding description is provided, which comprises program code means for performing all the steps of the preceding methods when said program is run on a computer or a network device.

According to yet another aspect of the invention, a computer program product is provided comprising program code means stored on a computer readable medium for carrying out the methods of the preceding description, when said program product is run on a computer or a network device.

According to another aspect of the present invention a computer data signal is provided. The computer data signal is embodied in a carrier wave and represents a program that makes the computer perform the steps of the method contained in the preceding description, when said computer program is run on a computer, or a network device.

According to yet another example embodiment a near field communication device is provided. The near field communication device is configured for outputting/providing indications of near field communication events. The near field communication device comprises a processing unit, a near field communication interface and a user interface. The processing unit is connected to said storage. The near field communication interface is connected to said processing unit. Said user interface is at least an output interface, which is connected to said processing unit. Said near field communication device is configured for detecting a near field communication event, obtaining at least one indication of near field communication events in accordance with said detected near field communication event, and outputting/providing said obtained at least one indication. Said indications of near field communication events may be obtained from said storage. Said obtained at least one indication can be outputted/provided via said user interface. The user interface may comprise optical display elements such as a display, a LED or the like, audio output elements such as a loudspeaker, a headphone or a interface to a in-vehicle audio system or tactile output elements such as vibrators, or surface configuration changers such as a Braille output element.

According to another aspect of the present invention a near field communication device configured for controlling near field communication events is provided. The near field communication device comprises a processing unit, a near field communication interface and a user interface. The processing unit is connected to said storage. The near field communication interface is connected to said processing unit. Said user interface is at least an output interface, which is connected to said processing unit. Said near field communication device is configured for detecting a near field communication event, identifying at least one of an entity causing said near field communication event and one or more application requests received from said entity, allocating a group of applications on said near field communication device for said identified near field communication entity based on the identifying information, and granting said entity causing said near field communication event access to said allocated applications.

In an example embodiment of the near field communication device said near field communication device is further configured for identifying the entity causing said near field communication event, determining a group of applications on said near field communication device allocated to said identified near field communication entity, and granting said entity causing said near field communication event access to said allocated applications.

The near field communication device may also be embodied as a smart card module for a mobile device, in This case the output interface provides a connection to a terminal in which said module is to be operated. In this embodiment the user output interface is embodies as an indirect user output interface for outputting/providing the obtained indication via a connected (external or even surrounding) display/output unit, as in the case of a connected headphone.

In an example embodiment said near field communication device is configured for identifying, registering and grouping detected near field communication events. The near field communication device may be is configured for identifying, registering and grouping detected near field communication events by comprising a component for identifying, registering and grouping detected near field communication events, that is connected to said processing unit. The near field communication device may be is configured for identifying, registering and grouping detected near field communication events by comprising a component for identifying, registering and grouping detected near field communication events, that is connected to said near field communication interface.

It is for example envisaged to identify, register and group said detected events before they are registered in said storage for example in a registry of detected near field communication events. It is also contemplated to use the invention in the invention for profiling for example the data collection behavior of e.g. different shops, locations and the like. This embodiment of a near field communication device is directed to a device in which indications of detected communication events are displayed on the display in a grouped manner.

In one embodiment of the present invention the near field communication device, e.g. the card management application of such a device, or it's alternative implementation through the contact-less font-end and a phone application will include the following capabilities:
an ability to identify application request to the card or the near field communication device,
an ability to categorize the requests from or to at least unknown applications and known applications,
an ability to identify if a transaction was started,
an ability to create a register or a log in which the above activities are stored, and
an ability to receive/initiate a request to output/show/provide the log information to the user.

The register/log would continuously gather information about activities, and the use of the register/log serves to expose read/transaction attempts and read/transaction actions to the card or the near field communication device. The information that would be shown to the user could happen through an application that would separate the different categories according to needs, and display information to the user. An application may be used to analyze the register/log, and provide warnings about potential threats to user ID and privacy simply by keeping track of which applications are being requested/requesting.

To strengthen this ability to identify threats applications could be categorized into private or public, where the user would receive a more severe warning if private applications were requested than if public applications were requested. The advantage of this solution is to create an automatic and visible means for the user to monitor which contact-less transactions and requests taking/taken place.

In another example embodiment said near field communication device is configured for obtaining at least one indication selected from the group consisting of playable sound files, video clips, vibration signalization files, splash screens, or images for output/provision. This embodiment is especially designed to perform the method of the invention related to the use of pre-stored indication to indicate the e.g. a kind of service or a brand of a service on a display of said near field communication device.

In this embodiment the near field communication device e.g. a mobile phone enables third parties to install indication packages comprising e.g. branding elements (e.g. playable sound files, video clips, splash screens, images) to the device in a single indication package (that may e.g. be based on XML). The installation package may also contain definitions of trigger conditions that will cause e.g. the branding elements of the indication package to be played, shown or reproduced. The trigger conditions may be for example a specific NDEF type, a specific Application ID (detected from a contact-less card reader), or something else that can be used to recognize the type of the contact-less application/service in use such as an identification of the requesting device. The indication package (with e.g. branding elements) may be installed in the device using for example over-the-air, local wireless communication channels (e.g. BT, WiFi, NFC, and IrDa), or by using physical connection such as USB or serial cable. The branding elements contents can be any data that the phone is able to reproduce, play or show to the user.

The near field communication device e.g. a cellular phone stores store the indication package with e.g. branding elements and is prepared to reproduce, play or show the indications (e.g. branding elements) according to the trigger conditions defined in the indication package. When the user e.g. touches a (RFID) tag or brings the phone close to an external reader, the phone checks the if a trigger condition if fulfilled (e.g. if a certain NDEF type is read from the tag or an AID asked by the external reader), and reproduces, plays or shows the branding element defined for that trigger condition. The near field communication device will be able to store multiple branding elements at the same time, enabling e.g. a payment service provider logo to be shown after payment process and a transportation provider logo to be shown when using the near field communication device e.g. as a ticket in a public transport system.

It should be noted that although above examples are about contact-less payment & ticketing, the invention is not limited to those use cases only it is also possible to use it as access device for concerts, museums, determining visitor motion profiles in exhibitions firms, as means for access control or the like. For example, in service discovery use cases the branding elements of the service/content provider could be shown based on a detected NDEF type.

This may be implemented by shrink wrapping the indication package (e.g. branding data and files) into an installation package. The indication package may contain the following elements:
a Name
a definition of at least one trigger condition (for instance NDEF type)
reproduction, execution and/or playing instructions, and
the media files itself.

This data could be defined as XML structure or proprietary binary data format.

With this implementation there is no need to implement different design variants of the near field communication device with different logos, as branding elements can be installed to the near field communication device phone dynamically, whereby branding elements can reproduces, played or shown based on trigger conditions defined with the branding elements, and multiple branding elements are supported in the device, each triggered in different situations, e.g. one for credit card, another for a public transport etc.

In yet another example embodiment said near field communication device, further comprises a cellular telephone. This embodiment is basically a mobile telephone with a near field communication ability. This telephone is capable of detecting and displaying and/or grouping communication events such as transaction requests and transactions.

It should be noted that it is also envisaged to utilize a combination of grouped indications and the use of pre stored indications that are linked to single requested applications or to an identification of a device requesting a transaction.

To enable the device to execute the method of the present invention a near field communication device according to the present invention may also be provided facilities or components to
download/receive a indication package such as e.g. a “Brand Package” or a “Service Package”
Recognize a indication package such as e.g. a Brand Package
Upon receiving a indication package,
   install and register at least one trigger condition
   store instructions for reproducing said indications
   store the media files of said indication package.
   store links to further information available over networks
Maintain integrity of an installed indication package such as a Brand Package
Provide means to (user/authorized service person) remove an indication package e.g. a Branding Packages
Provide means to download, maintain and upgrade indication packages such as Branding Packages, and
If the indication package is linked or tied to a certain application, maintain the connection/link between the indication package and the application.

The maintaining of the integrity of the indication package may be performed by dedicated indication package updates or may be performed by uploading small data transfers during or subsequently to a transaction.

In yet another example embodiment of the present invention the near field communication device, further comprises means for categorizing various applications residing in the secure smart card module into different groups, and means for creating rules for making associations between the different groups for enabling allowing/denying responding to requests of external near field communication reader devices based on said rules.

In still another example embodiment of the present invention said near field communication device is further provided with a dedicated user interface configured for receiving user input for creating said rules.

According to just another aspect of the present invention a near field smart card module is provided. The near field communication card comprises a controller, and an interface to a near field communication module, an interface to a processing unit, a secure memory element groups of applications, and a database storing association rules connected to said controller. The data in the database of association rules are provided to store association rules, defining associations between each communication event or each (identified) entity causing a communication event and a group of applications accessible (or also accessible) for the identified event/entity for controlling access to applications based on the grouping of the applications. In the secure memory element the applications are grouped into one or more groups based on characteristics of the applications. This implementation represents a smart card to be inserted into a device such as a mobile NFC device (e.g. a NFC enabled mobile telephone). With such a smart card any NFC device may provide the advantages of the present invention to a user of providing “grouped access” of identified requests or identified requesting entities to and NFC device having a smart card module interface.

In another example embodiment (or according to another aspect) of the invention the smart card module is provided with an internal memory (connected to said controller) to register detected near field communication events in a registry of detected near field communication events for logging all NFC communication events, or for logging all transaction requests or at least all performed transactions.

The smart card module may also be configured for detecting a near field communication event (on a connected NFC device), for obtaining at least one indication of near field communication events in accordance with said detected near field communication event, and for outputting/providing said at least one obtained indication (by transferring respective data to said NFC device via a smart card module interface). It should be clear that the smart card module may also be provided with a controller and a storage to be able to perform the necessary steps and to induce the NFC terminal to notify the smart card module of NFC events and to output the respective data to a user. That is, the smart card module may be provided with a program inducing the NFC device to act as if the functionality of the invention is already built-in the NFC device. Thereby all components of the invention may also be incorporated into a smart card (module) designed for a NFC (mobile) device with an smart card interface an not only into an NFC device itself but into a smart card module to provide the functionality of the present invention to a connected NFC device via a smart card (module) interface.

In another example embodiment (or according to another aspect) of the invention the smart card module is provided with an internal memory (connected to said controller) and a control logic to detect near field communication events (at least on a connected NFC device), to obtain at least one indication of near field communication events selected from the group consisting of playable sound files, video clips, vibration signalization files, splash screens, or images in accordance with said detected near field communication event, and to output/provide said at least one obtained indication. With this embodiment a smart card module inserted in a conventional NFC device (with smart card interface) may be used to provide the above mentioned functionality of “branding” NFC events or e.g. transactions.

Thereby the components of the invention may also be incorporated into a smart card (module) (designed for a NFC mobile device with a smart card module interface) to provide the functionality of the present invention to a NFC device connected via a smart card module interface to said smart card module. It is also envisaged to implement also additional components for performing the method of the present invention in the form of respective components into smart card modules of the present invention.

In another example embodiment a near field smart card module is further provided with means for categorizing various applications residing in the secure smart card module into different groups, and means for creating rules for making associations between the different groups for enabling allowing/denying responding to requests of external near field communication reader devices based on said rules.

In still another example embodiment of the present invention said near field smart card module is further provided with a dedicated user interface configured for receiving user input for creating said rules.

In the following, the invention will be described in detail by referring to the enclosed drawings in which:

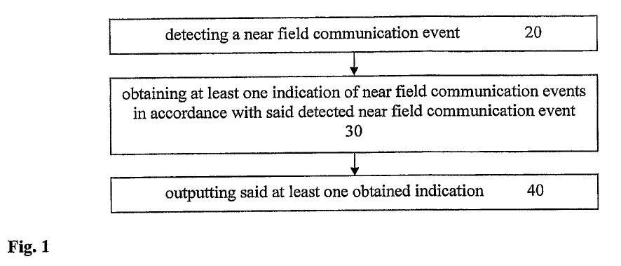

FIG. 1 is a flowchart of a method for outputting/providing indications of near field communication events on a near field communication device according to one aspect of the present invention.

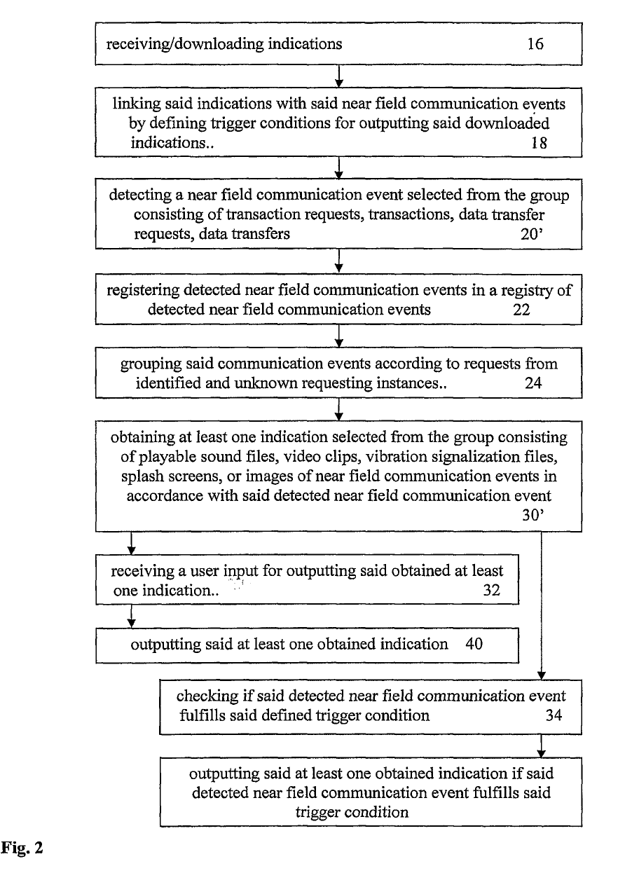

FIG. 2 is a flowchart of a more sophisticated embodiment of a method according to the present invention.

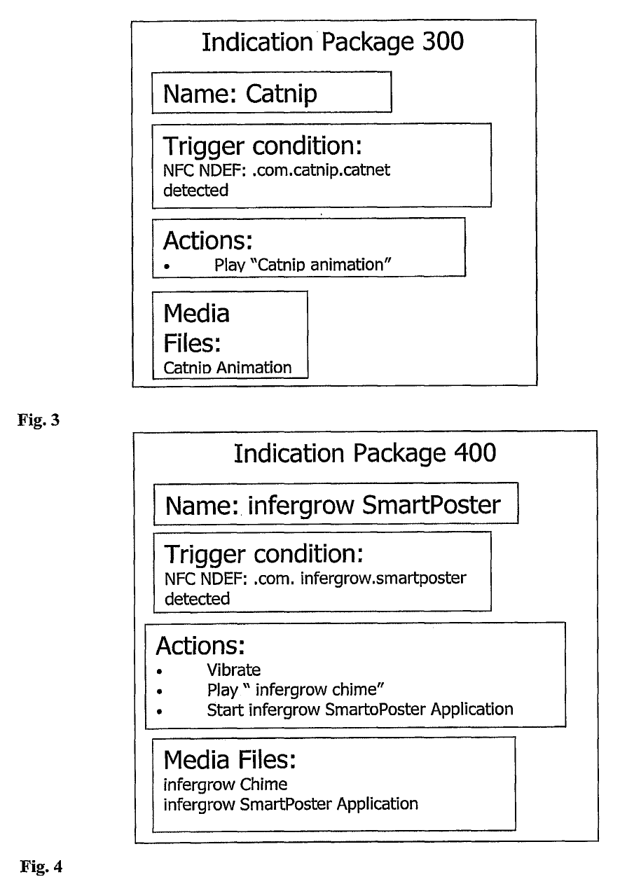

FIGS. 3 to 5 show different embodiment of indication packages.

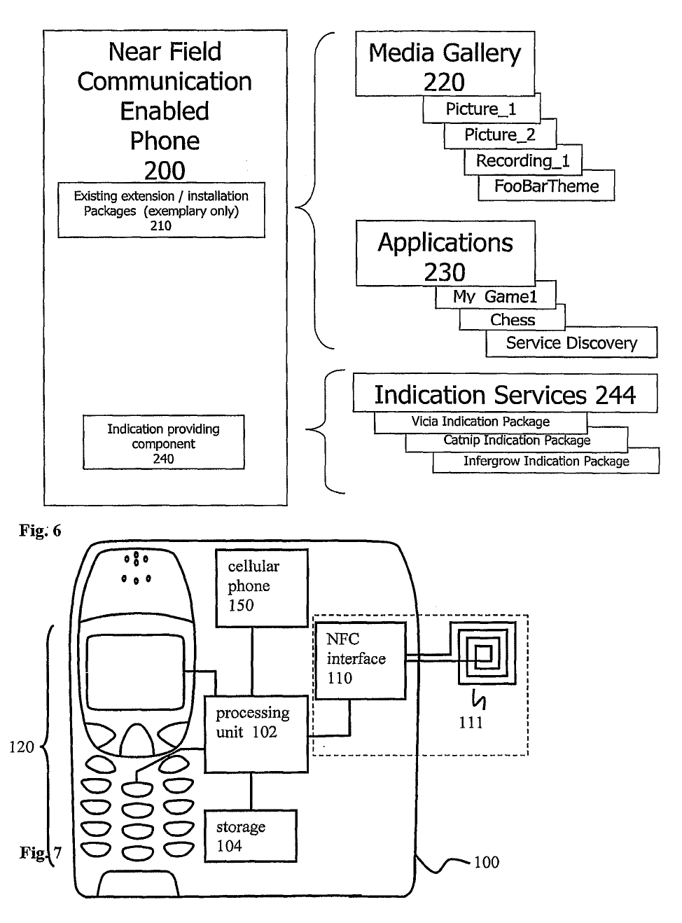

FIG. 6 is a schematic example of a near field communication device according to the present invention to indicate different functionality of the known installation package and an indication providing component.

FIG. 7 is an example of a near field communication device according to the present invention.

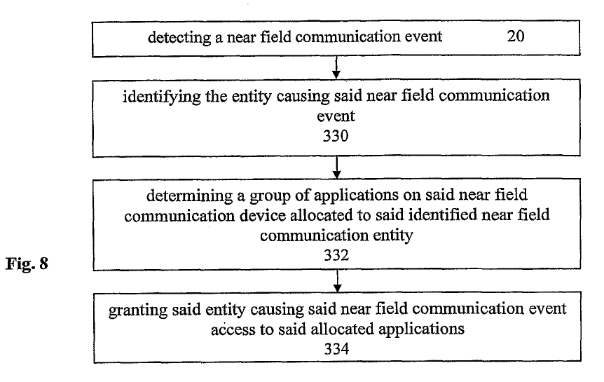

FIG. 8 is a flowchart of a method for controlling the access of near field communication events to near field communication applications on a near field communication device according to one aspect of the present invention.

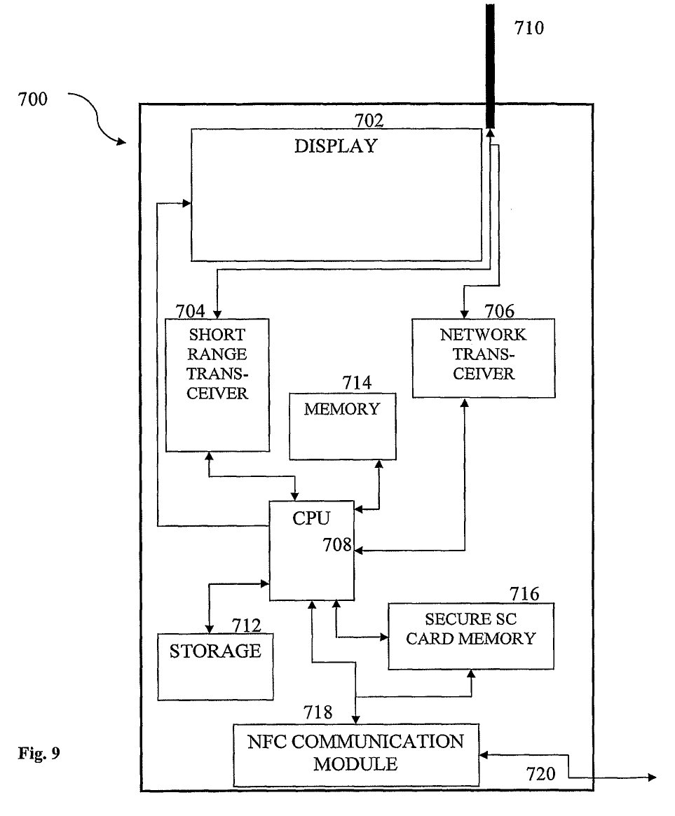

FIG. 9 is an example of a near field communication device according to the present invention.

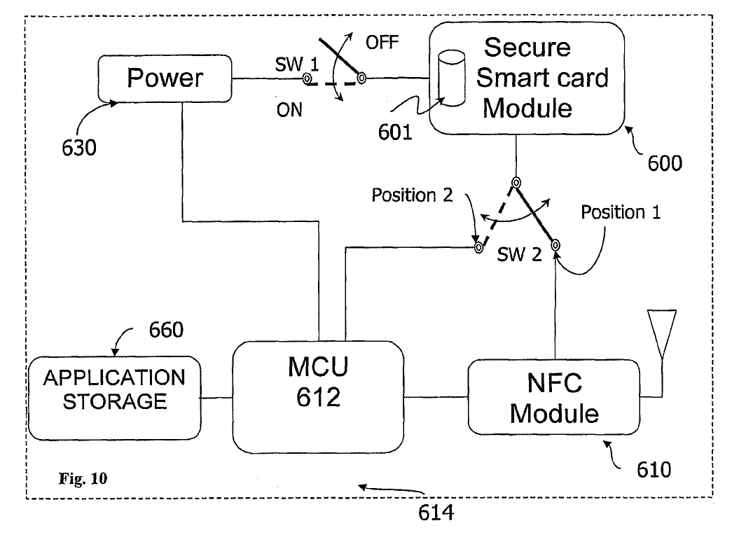

FIG. 10 is an example of a mobile device according to an embodiment of the present invention

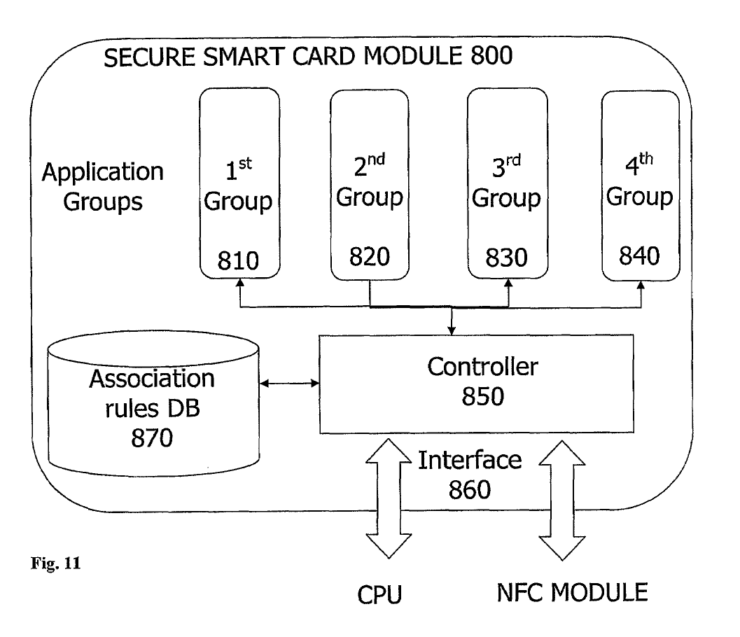

FIG. 11 is an example of a secure smart card (module) for the use in a terminal device of e.g. FIG. 9 or 10.

In the detailed description, which follows, identical components have been given the same reference numerals, regardless of whether they are shown in different embodiments of the present invention. In order to clearly and concisely illustrate the present invention, the drawings may not necessarily be to scale and certain features may be shown in somewhat schematic form.

FIG. 1 is a flowchart of a method for outputting/providing indications of near field communication events on a near field communication device according to a basic aspect of the present invention. The method for outputting/providing indications of near field communication events on a near field communication device, comprises detecting 20 a near field communication event, obtaining 30 at least one indication of near field communication events in accordance with said detected near field communication event, and outputting/providing 40 said at least one obtained indication.

The basic idea behind this invention is to create a logic to execute the method, which makes the transaction services more controllable for a mobile terminal user by exposing various transaction-requests to the user. This may be achieved in more sophisticated implementations of the present invention by grouping applications in the secure smart card into different types of sets that are controllable by the user through a dedicated user interface. Further it is also envisaged to provide indications of the transaction service provider during transaction process as a feature for the user interface.

FIG. 2 is a flowchart of a more sophisticated embodiment of a method according to the present invention. In contrast to the embodiment of FIG. 1 the method starts with receiving or downloading 16 indications. The downloading may be performed by requesting/receiving and installing said indications e.g. as a package. After the download said indications are linked/allocated to said near field communication events by defining 18 trigger conditions for outputting/providing said downloaded indications. The trigger definitions may be defined during an installation process or by e.g. user input. These actions represent an initiation of the device for detecting 20′ a near field communication event selected from the group consisting of transaction requests, transactions, data transfer requests and data transfers. Then, detected near field communication events are registered 22 in a registry of detected near field communication events. Detected communication events are grouped 24 according to requests from or for identified and unknown requesting/requested instances/applications.

Then at least one indication selected from the group consisting of playable sound files, video clips, vibration signalization files, splash screens, or images of near field communication events are obtained 30′ in accordance with said detected near field communication event. That means that the device actually retrieves or generates certain content for (preferably identified applications/requesting instances) related to the identified application/requesting instance. It is also envisaged to obtain a standard “unknown” indication in case of a non identified application/requesting instance.

In the next step the flowchart branches in a first branch by receiving 32 a user input for outputting/providing said at least one obtained indication, and outputting/providing 40 said at least one obtained indication.

The flowchart may also branch in a second branch by checking if said detected near field communication event fulfills 34 any of said trigger conditions defined in step 18, and outputting/providing 40′ said at least one obtained indication if said detected near field communication event fulfills any of said trigger conditions.

FIGS. 3 to 5 show different embodiment of indication packages.

In FIG. 3 the Indication Package 300 is related to virtual service provider called “catnip”.

The indication package has a name “catnip”, a defined trigger condition that is the detection of a signal interpretable as “.com.catnip.catnet”. If the trigger condition is fulfilled i.e. an signal has been received that has been interpreted as comprising the term “.com.catnip.catnet” the defined action “play Catnip animation” (which is also contained in the indication package) is triggered.

In FIG. 4 the Indication Package 400 is related to virtual service/product provider called “infergrow”. The indication package has a name “infergrow SmartPoster”. This indication package has the detection of the term “.com.infergrow.smartposter” as defined trigger condition. If the trigger condition is fulfilled i.e. an signal has been received that has been interpreted as comprising the term “.com.infergrow.smartposter” the defined actions “vibrate”, play “infergrow chime” and “start infergrow SmartPoster” is activated. To be able to perform these actions the indication package is also provided with medial files “infergrow chime” and “start infergrow SmartPoster application”.

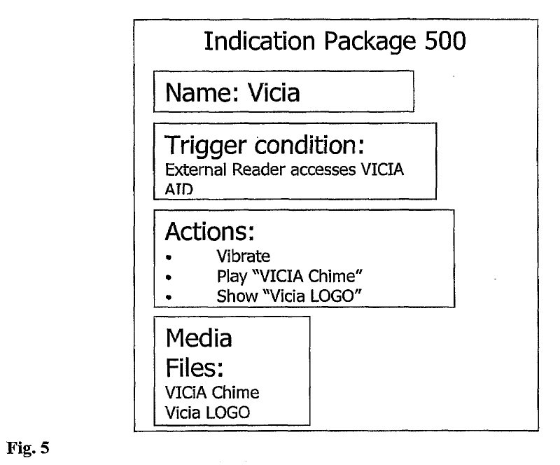

In FIG. 5 the Indication Package 500 is related to virtual service/product provider called “Vicia”. The indication package has a name of the service/product provider “Vicia”. This indication package is provided with the media files “VICIA Chime” and with the “Vicia Logo”. The trigger condition is set to an access of an external reader to a “VICIA AID” application of the near field communication device. If the NFC device considers the trigger condition as being fulfilled the actions “vibrate”; play “VICIA chime” and “Show Vicia LOGO” is activated. That is, as soon a reader tries to access the respective application on the phone the phone vibrates plays a characteristic tune and depicts a logo related to the accessed function or to the accessed application on a display of the near field communication device.

FIG. 6 is a schematic example of a near field communication device according to one embodiment of the present invention to indicating different functionality of the known installation package and an indication providing component. In the figure a NFC-enabled mobile telephone 200 is provided with known NFC-functionality 210 using known installation packages such a media gallery 220 and Applications 230. The media gallery 220 comprises for example pictures 1 and 2, recorded files and or a “FooBar” theme. The Application (section) 244 may comprises for example a Game, the game “chess” or a service discovery application/protocol.

In addition to these conventional NFC applications an indication providing component 240 is provided that comprises indication Services such as the indication packages “Vicia indication package” of FIG. 5, the “Catnip indication Package” of FIG. 3 and the “Infergrow Indication Package”. It may also be envisaged to provide the battery pack of said NFC enabled phone with a NFC (e.g. RFID) tag to cause the device to display a LOGO of the battery manufacturer on a display if other NFC signals are present.

FIG. 7 depict a near field communication device 100 comprising a mobile or cellular telephone or telephone module 150. The near field communication device 100 is configured for outputting/providing indications of near field communication events. The near field communication device 100 comprises a processing unit 100, a storage 104, a near field communication interface 110, and a user interface 120. The storage 104 is connected to said processing unit 102, and said user interface 120 is also connected to said a processing unit 102. The near field communication interface 110 is also connected to said processing unit 102.

The near field communication device is configured for detecting a near field communication event, obtaining at least one indication of near field communication events in accordance with said detected near field communication event, and outputting/providing said obtained at least one indication via said user interface 120.

The near field communication device (NFC) is further configured for identifying, registering and grouping detected near field communication events detected via said NFC interface 110. It is also contemplated to use a dedicated component i.e. an Identifikator connected to said NFC interface 110 for identifying detected near field communication events. It is also contemplated to use a Registrator that is (also) connected to said processing unit 110 and to said storage 104 for identifying detected near field communication events.

It is also contemplated to use a dedicated hardware component i.e. a Registrator connected to said NFC interface 110, for registering detected/identified near field communication events. It is also envisaged to implement connect said Registrator to said storage 104, and/or to said storage, for registering detected/identified near field communication events. The Registrator may also be connected to said Identifikator.

The near field communication device (NFC) may further comprise a hardware component for grouping (a Grouper) detected/identified/registered near field communication events received via said NFC interface 110. It is envisaged to connect the Grouper with the storage 104 and/or with the processing unit 102. It is also envisaged to connect such a Grouper with a Registrator and or an Identifikator.

The NFC interface is connected to a NFC antenna 111 indicated as a multi-loop antenna. The near field communication device is configured for detecting a near field communication event, obtaining at least one indication of near field communication events in accordance with said detected near field communication event, and outputting/providing said obtained at least one indication.

The near field communication device is configured for obtaining at least one indication selected from the group consisting of playable sound files, video clips, vibration signalization files, splash screens, or images stored in said storage 104 for play back. The near field communication device is further comprising a cellular telephone 150. That is, the device may also be considered as being a near field communication enabled mobile cellular telephone.

FIG. 8 is a flowchart of a method for controlling the access of near field communication events to near field communication applications on a near field communication device according to one embodiment of the present invention. The method comprises the steps of: detecting 20 a near field communication event, identifying 330 the entity causing said near field communication event, determining 332 a group of applications on said near field communication device allocated to said identified near field communication entity, and granting 334 said entity causing said near field communication event access to said allocated applications. According to an alternative embodiment of the present invention, the step of identifying 330 the entity causing said near field communication event may be replaced with step 330′ where one or more application requests received from said near field communication entity are identified and based on that information, at least one group of applications is allocated to be available to said entity causing said near field communication event reflecting to step 332 in FIG. 8.

It should be noted that the methods depicted in FIGS. 1, 2, and 8 may be combined to a single flowchart wherein the features disclosed in these figures are combined in a singe flowchart. This may be used to detect events, determine/identifying the requesting entity and the requested application, logging said detected NFC-event and depicting the requested application, the identity of the requesting entity and possible all applications that are accessible by the requesting entity according to association rules of the device (or a smart card in the device). That is, the present invention combines features of logging near field communication events such as transactions (data transfers) and transaction requests, with a possibility of “branding” i.e. playing back data related to a transaction or a transaction request with an access control for controlling the access of devices or of requests to applications on an NFC device. It is also envisaged to simultaneously display a detected communication event, (e.g. in form of an identification of a requesting device), display or reproduce information related to the requesting instance or to a requested application together with a list of all applications accessible by said requesting entity or by said communication event.

FIG. 9 illustrates a mobile device 700 according to an embodiment of the present invention. As can be seen from FIG. 9, the terminal 700 includes the general wide-area network 706 and short-range communication 704 interfaces/transceivers. In addition to the general components, there are the NFC communication module 718 and secure smart card interface that holds the secure applications in a secured memory area only partly accessible to the user of the mobile device. The mobile device 700 further comprises an antenna 710 indicated as a ground-plane antenna 710 that is connected to said general wide-area network 706 and short-range communication 704 interfaces. As shown in FIG. 7 the near field communication device 700 comprises a memory 714 and storage 712, a display 702, a NFC communication module 720 and a processing unit (CPU) 708. The mobile device is also provided with a secure smart card 716 having an internal card memory. The secure smart card 716 is connected to the mobile device 700 via a (not depicted) smart card interface providing an electrical and mechanical connection between the secure smart card 716 and the mobile device.

The near field communication device 700 may be configured for outputting/providing indications of near field communication events. The near field communication device may also be configured for detecting a near field communication event, obtaining at least one indication of near field communication events in accordance with said detected near field communication event, and outputting/providing said obtained at least one indication via said user interface 702. The near field communication device 700 (NFC) may also be configured for identifying, registering and grouping detected near field communication events detected via said NFC communication module 718.

It is also contemplated to use a dedicated component i.e. an Identifikator (e.g. the CPU 708 in connection with storage 712) connected to said NFC communication module 718 for identifying detected near field communication events/or NFC entities causing NFC events. It is also contemplated to use a Registrator (e.g. the CPU 708 in turn in connection with storage 712 or in connection with memory 714) for identifying detected near field communication events.

The near field communication device (NFC) may further comprise a hardware component for grouping (a Grouper) detected/identified/registered near field communication events received via said NFC interface 110. It is envisaged to connect the Grouper with the storage 104 and/or with the processing unit 102. It is also envisaged to connect such a Grouper with a Registrator and or an Identifikator.

FIG. 10 illustrates schematically an example arrangement of a smart card module and an NFC module in connection with other elements within a mobile device according to an embodiment of the present invention. According to the depicted embodiment of the present invention a secure smart card element 600 is integrated into a mobile device (not shown in FIG. 10). Said smart card module 600 may also comprise a secure storage area module 601. Said secure storage module 601 may be used for storing different data in a tamperproof environment on the smart card. Said data may comprise secure applications, private data, important receipts and electronic tickets or the like. As illustrated, the secure smart card element 600 is connected to a power source via a user controllable switch SW1, which provides necessary power to the secure smart card element for powering it up or shutting it down. The secure smart card element/module 600 is further connected via a switch SW2 either to a Near Field Communication (NFC) interface 610 providing connectivity with external devices by means of using e.g. RFID or optical connection, or alternatively to terminal MCU 612 for providing control to the secure smart card element 600. It should be noted that the term mobile control unit (MCU) and central processing unit (CPU) are used synonymously throughout the description.

The NFC interface 610 provides necessary means to communicate with external tags/devices using e.g. RFID technology so that the terminal can conduct RFID-based payment and ticketing transactions, but not limited thereto. The NFC interface 610 allows both reading and writing operations to be conducted both to and from external tags/devices and also peer-to-peer type communication between two NFC terminals. The secure smart card element 600 is directly linked to the NFC interface 610, by means of said switch SW2, in order to ensure that there will be no unnecessary delays within terminal logic that might hinder/prevent transactions due to the nature or RFID communication, which will typically require fast response times. A RFID transaction, for instance, will be typically conducted within, e.g., hundreds of milliseconds.

The power switching of the secure smart card module (switch 1) is not necessarily that important for implementing the present invention, but the switching between the secure smart card module between CPU (user controlling) and the NFC module (external devices) can be considered relevant. Here it can be seen that there are not many possibilities for a user to take control these various transaction operations. For example an external point of sale (POS) terminal may send queries to the secure smart card module for finding applications it requests and upon finding a preferred application, start communicating with the application for conducting the transaction or like. This may be implemented by: the POS tries to find e.g. an identification of a credit card provider, if such an identification has been found, a transaction procedure may be initiated. If no such identification can be found, the POS queries e.g. the identification of another credit card provider and the POS can check the applications of the terminal one-by-one. Actually a user does not have any control over this transaction procedure during the actual operation unless some additional control features are provided.

FIG. 11 depicts an embodiment of a smart card according to the present invention, which provides user of a mobile device control over the transaction events. The near field (secure) smart card (module) 800 depicted in FIG. 11 comprises a controller 850, an interface 860 to a near field communication module and to a processing unit, groups of applications 810, 820, 830, 840 and a database storing 870 association rules, wherein all these components are connected to said controller 850. The groups of applications may be stored in a (not depicted) storage and are accessible from an external (NFC) terminal device via said interface in certain groups. It is also envisaged to group only the access to the applications according to information/rules stored in said database of association rules.

In FIG. 11 all applications residing in the secure smart card module are categorized or grouped based on the characteristics of the applications. When these applications are categorized into various application groups having certain common characteristics, certain (automatic/user defined) association rules can be defined for the application rules to block “visibility” of certain groups when a query for an application of another group is detected. This kind of association database provides necessary means for a user to have some kind of control over “visible” applications, which makes screening of the mobile device contents more difficult. Additionally this may also prevent possible scenarios wherein a certain application is set to too lower security setting and, e.g., a screening device may find a credit card application that is responsive to an identification and allowing a transaction procedure.

The association rules database (or database of association rules) 870 may include some “factory-based” general settings for the association database. However it is envisaged to enable a user to tailor the rules for the association database based on his her needs for example via a dedicated user interface. The rules do not necessary block certain applications for functioning, but may provide a sensible alert or require user to provide acceptance for providing “exposure” for certain applications.

According to embodiment illustrated in FIG. 11 the secure smart card module is responsible for this blocking/grouping operation.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. Method comprising:
detecting a near field communication event,
obtaining at least one indication of near field communication events in accordance with said detected near field communication event, and
providing said at least one obtained indication.

2. Method comprising:
detecting a near field communication event,
identifying at least one of an entity causing said near field communication event and one or more application requests received from said entity,
allocating a group of applications on said near field communication device for said identified near field communication entity based on the identifying information, and
granting said entity causing said near field communication event access to said allocated applications.

3. Method according to claim 1 further comprising:
identifying the near field communication entity causing said near field communication event,
determining a group of applications on said near field communication device allocated to said identified near field communication entity, and
granting said entity causing said near field communication event access to said allocated applications.

4. Method according to claim 1, wherein near field communication event is selected from the group consisting of transaction requests, transactions, data transfer requests, data transfers.

5. Method according to claim 1, further comprising:
registering detected near field communication events in a registry of detected near field communication events.

6. Method according to claim 3, further comprising:
grouping said applications of the near field communication device according to a received user input.

7. Method according to claim 1, further comprising:
grouping said communication events.

8. Method according to claim 7, wherein said grouping is performed according to requests from identified and unknown requesting instances.

9. Method according to claim 7, further comprising
determining the position of the near field communication device, wherein said grouping is performed according to location information.

10. Method according to claim 1, further comprising:
receiving a user input for providing said obtained at least one indication.

11. Method according to claim 1, wherein said step of obtaining said indications in accordance with said detected near field communication event further comprises obtaining indications selected from the group consisting of playable sound files, video clips, vibration signalization files, splash screens, or images.

12. Method according to claim 10, further comprising
downloading said indications, and
linking said indications with said near field communication events.

13. Method according to claim 12, wherein said linking is performed by defining trigger conditions for providing said downloaded indications.

14. Method according to claim 13, further comprising:
checking if said detected near field communication event fulfills said defined trigger condition; and
providing said obtained indications, if said detected near field communication event fulfills said trigger condition.

15. Computer program product capable to providing indications of near field communication events on a near field communication device, comprising program code sections for carrying out the method of claim 1, when said program is run on a controller, processor-based device, a computer, a microprocessor based device, a terminal, a network device, a mobile terminal or a mobile communication enabled terminal.

16. Computer program product for providing indications of near field communication events on a near field communication device, comprising program code sections stored on a machine-readable medium for carrying out the method of claim 1.

17. Software tool capable to providing indications of near field communication events on a near field communication device, comprising program portions for carrying out the operations of claim 1, when said program is implemented in a computer program for being executed on a controller, processor-based device, a microprocessor based device, processing device, a terminal device, a network device, a mobile terminal, or a mobile communication enabled terminal.

18. Computer data signal embodied in a carrier wave and representing instructions for providing indications of near field communication events on a near field communication device, which when executed by a processor cause the method of claim 1 to be carried out.

19. An apparatus comprising:
a processing unit
configured for detecting a near field communication event, obtaining at least one indication of near field communication events in accordance with said detected near field communication event, and providing said obtained at least one indication.

20. An apparatus comprising:
a processing unit
configured for detecting a near field communication event, identifying at least one of an entity causing said near field communication event or one or more application requests received from said entity, allocating a group of applications for said identified near field communication entity based on the identifying information, and granting said entity causing said near field communication event access to said allocated applications.

21. according to claim 18, wherein said processing unit is further configured for identifying the entity causing said near field communication event, determining a group of applications allocated to said identified near field communication entity, and granting said entity causing said near field communication event access to said allocated applications.

22. An apparatus according to claim 18, wherein said processing unit is configured for identifying, registering and grouping detected near field communication events.

23. An apparatus according to claim 18, wherein said processing unit is configured for obtaining at least one indication selected from the group consisting of playable sound files, video clips, vibration signalization files, splash screens, or images.

24. An apparatus according to claim 18, further comprising a cellular telephone.

25. An apparatus according to claim 18 embodied as a smart card.

26. An apparatus according to claim 25, further comprising means for categorizing various applications residing in the smart card module into different groups, and means for creating rules for making associations between the different groups for enabling allowing/denying responding to requests from an external near field communication reader device based on said rules.

27. An apparatus according to claim 26, further being provided with a dedicated user interface configured for receiving user input for creating said rules.

28. An apparatus comprising:
a controller configured to access
a secure memory element that stores applications into one or more groups, wherein the applications are grouped into one or more groups based on characteristics of the applications, and wherein
said controller is configured to be responsive to association rules that define association between the one or more groups in order to control access to applications based on the grouping of the applications.

29. An apparatus according to claim 28, further comprising means for categorizing various applications residing in the secure smart card module into different groups, and means for creating rules for making associations between the different groups for enabling allowing/denying responding to requests from an external near field communication reader device based on said rules.

30. An apparatus according to claim 29, further provided with a dedicated user interface configured for receiving user input for creating said rules.
